(19) United States
(12) Patent Application Publication
(10) Pub. No.: US 2022/0215286 A1
(43) Pub. Date: Jul. 7, 2022

(54) ACTIVE LEARNING IMPROVING SIMILAR TASK RECOMMENDATIONS

(71) Applicant: INTERNATIONAL BUSINESS MACHINES CORPORATION, ARMONK, NY (US)

(72) Inventors: Alexandre Luz Xavier Da Costa, Stuttgart (DE); Lars Bremer, Boeblingen (DE); Karin Steckler, Herrenberg (DE); Thuany Karoline Stuart, Nice (FR)

(21) Appl. No.: 17/140,697

(22) Filed: Jan. 4, 2021

(51) Int. Cl. G06N 20/00; G06N 5/04; G06Q 10/06

(52) U.S. Cl. CPC G06N 20/00; G06Q 10/06311; G06N 5/04

(57) ABSTRACT

A method, computer system, and computer program product for training a machine learning model for use by a task management system are provided. The embodiment may include presenting a task to be resolved to a user via a user interface. The embodiment may also include presenting a further task to be resolved to the user via the user interface. The embodiment may further include predicting time to be spent on the further task presented to the user. The embodiment may also include determining actual time the user spent completing the further task. The embodiment may further include training a machine learning model for a subsequent similar task based on the predicted time and the determined actual time.

### BACKGROUND

The present invention relates, generally, to the field of computing, and more particularly to task management systems.

The task management system enables managing a task through its life cycle, which usually involves planning testing, tracking, and reporting, etc. The task management system can help either individual achieve goals, or groups of individuals collaborate and share knowledge for the accomplishment of collective goals. Effective task management requires managing all aspects of a task, including its status, priority, time, human and financial resources assignments, recurrence, dependency, notifications, and so on. Managing multiple individuals or team tasks may be assisted by specialized software, such as workflow or project management software.

### SUMMARY

According to one embodiment, a method, computer system, and computer program product for training a machine learning model for use by a task management system are provided. The embodiment may include presenting a task to be resolved to a user via a user interface. The embodiment may also include presenting a further task to be resolved to the user via the user interface. The embodiment may further include predicting a time to be spent on the further task presented to the user. The embodiment may also include determining an actual time the user spent for completing the further task. The embodiment may further include training a machine learning model for a subsequent similar task based on the predicted time and the determined actual time.

### BRIEF DESCRIPTION OF THE SEVERAL VIEWS OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a similar task recommendation process according to at least one embodiment;

FIG. 3 is a functional block diagram of a similar task recommendation process according to at least one embodiment;

FIG. 4 is a diagram showing several examples of operation of a computer system for labeling tasks according to at least one embodiment;

FIG. 5 is a block diagram of internal and external components of computers and servers depicted in FIG. 1 according to at least one embodiment;

FIG. 6 depicts a cloud computing environment according to an embodiment of the present invention; and

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to task management systems. The following described exemplary embodiments provide a system, method, and program product to monitor user behavior and draw a conclusion of the user's agreement to a machine learning prediction, and implicit user feedback may be collected to train the machine learning model. Therefore, the present embodiment has the capacity to improve the technical field of task management systems by training a machine learning model to analyze implicit user feedback to automatically identify similar tasks for the user without the user's direct feedback.

As previously described, a task management system enables managing a task through its life cycle, which usually involves planning testing, tracking, and reporting, etc. The task management system can help either individual achieve goals, or groups of individuals collaborate and share knowledge for the accomplishment of collective goals. Effective task management requires managing all aspects of a task, including its status, priority, time, human and financial resources assignments, recurrence, dependency, notifications, and so on. Managing multiple individuals or team tasks may be assisted by specialized software, such as workflow or project management software.

The task management system may contain tasks with certain attributes. Humans have to resolve these tasks. Such tasks often contain attributes that allow a user to determine similarity. Resolving tasks can be time-consuming. Often, some tasks are very different and may require the user to resolve the tasks to completely think differently when doing so. By identifying and suggesting similar tasks during the workflow, it may be possible to reduce the severity of the rethinking and therefore the time that it takes to resolve such tasks. One way to identify similar tasks is to use a machine learning classifier. However, it may be difficult to predict the similarity of tasks and they often are user specific. Therefore, user feedback may be necessary to train a machine learning model. One way to obtain user feedback is to ask the user after a prediction has been presented if such a prediction is accurate or not. It may be cumbersome to ask the user to make such a judgment about the similarity prediction. Typically, the user's workflow may be interrupted by such questionnaires. Therefore, it may be advantageous to remove the need to ask the user for such feedback.

According to one embodiment, the claimed invention may remove the requirement for active user feedback. The present embodiment may collect information about the user's behavior when the user handles a certain task. For example, the present embodiment may collect information about user interaction with user interface selections and how much time is spent on particular task items. Such implicit user feedback may be utilized to train a machine learning model that may predict a next similar task for the user.

The present invention may be a system, a method, and/or a computer program product at any possible technical detail level of integration. The computer program product may include the computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or another device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for automatically improving similar task recommendations based on user behaviors and runtime on workflow utilizing a machine learning technology.

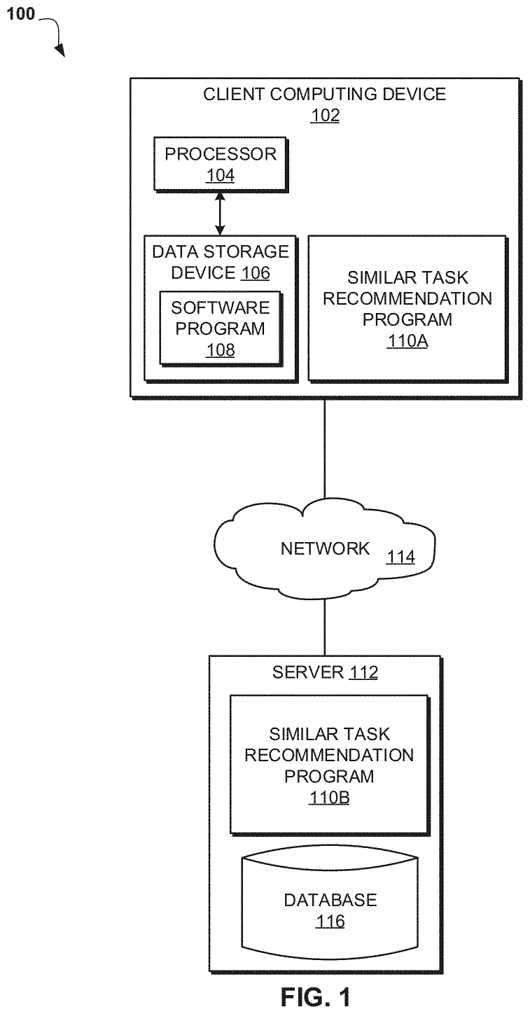

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112 of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

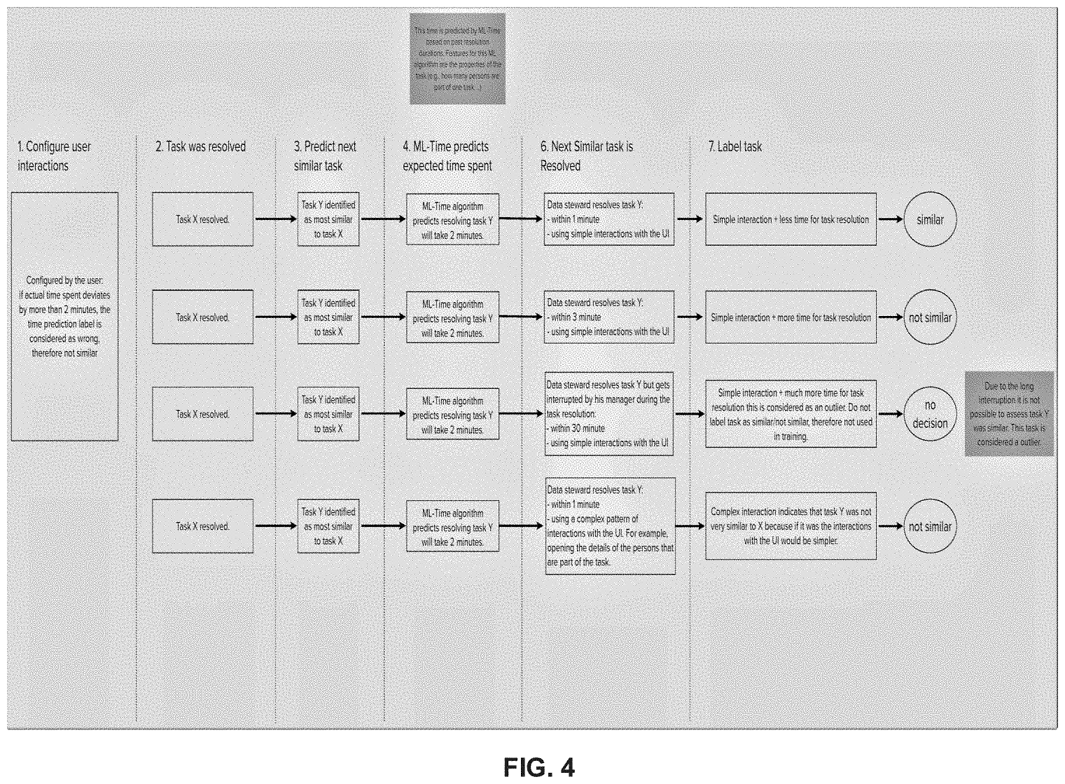

Client computing device 102 may include a processor 104 and a data storage device 106 that is enabled to host and run a software program 108 and a similar task recommendation program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a similar task recommendation program 110B and a database 116 and communicating with the client computing device 102 via the communication network 114, in accordance with embodiments of the invention. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

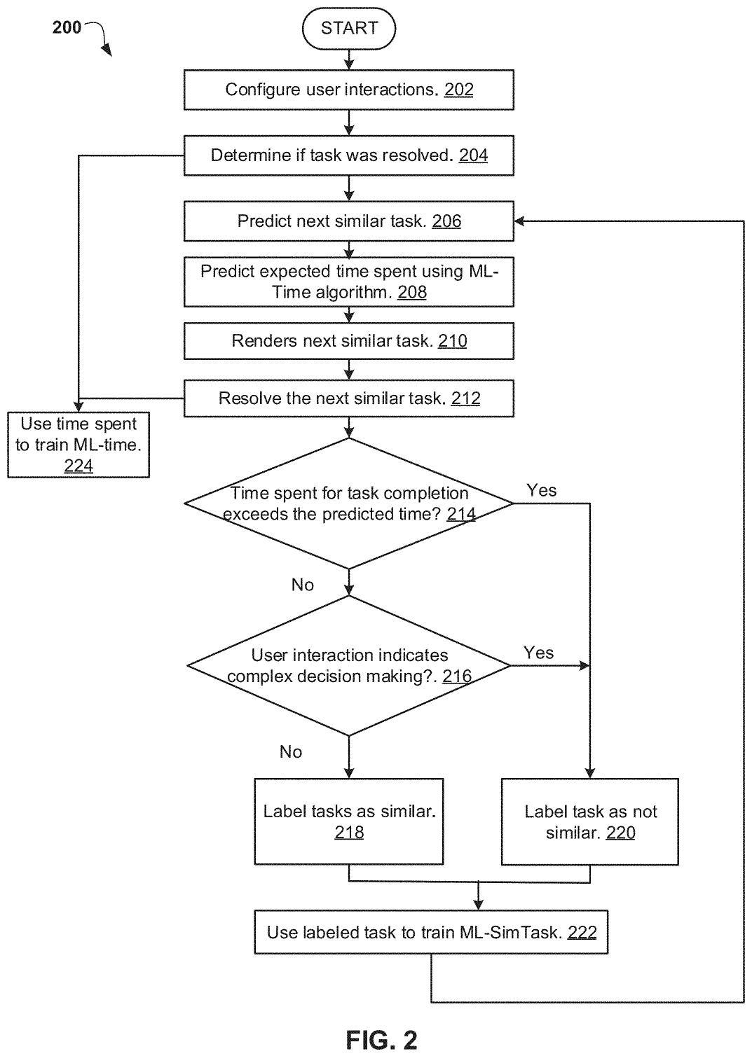

According to the present embodiment, the similar task recommendation program 110A, 110B may be a program capable of configuring user interactions and determining if a certain task has been resolved to predict the next similar tasks. The present embodiment may also predict the expected time spent using a machine learning time algorithm and render the next similar task. The present embodiment may further capture user interaction data when the user tries to resolve similar tasks and send the data to the machine learning system. The similar task recommendation process is explained in further detail below with respect to FIG. 2.

FIG. 2 is an operational flowchart illustrating a similar task recommendation process 200 according to at least one embodiment. At 202, the similar task recommendation program 110A, 110B configures user interactions. According to one embodiment, the similar task recommendation program 110A, 110B may allow a user to configure the system and such configuration may be stored in the configuration system. The configuration system may store how a usage pattern is interpreted. For example, the similar task recommendation program 110A, 110B may consider that the threshold time of the time it took for the user to complete a certain task, which has been suggested as a similar task, is too long, and determine that the task was not so similar. Such information may be considered to take into account the complexities of the task in later steps.

At 204, the similar task recommendation program 110A, 110B determines if a task was resolved. According to one embodiment the similar task recommendation program 110A, 110B may determine whether a user has received a certain task and the user completed the task. In another embodiment, the similar task recommendation program 110A, 110B may monitor the time spent on the tasks by the user, and collect the time information to train a machine learning system at step 224.

At 206, the similar task recommendation program 110A, 110B predicts the next similar task. According to one embodiment, the similar task recommendation program 110A, 110B may predict the next similar task using a machine learning classifier. For example, if a user once resolved a particular task, the similar task recommendation program 110A, 110B may utilize a machine learning system to predict a similar task based on the content of the task, characteristics of such tasks, types of such tasks, tools or domain knowledge used for resolving the task to predict a similar task for the user. In one embodiment, the tools or domain knowledge may only be used when those tools or domain knowledge are obvious from the task.

At 208, the similar task recommendation program 110A, 110B predicts expected time spent using a machine learning time algorithm. According to one embodiment the similar task recommendation program 110A, 110B may predict an expected time to be spent on the predicted similar task by the same user. For example, if a user has completed task A and the similar task recommendation program 110A, 110B predicts that the next similar task is task A′, the similar task recommendation program 110A, 110B may predict that the time that needs to be spent on task A′ may be similar to the time that was actually spent on task A.

At 210, the similar task recommendation program 110A, 110B renders the next similar task. According to one embodiment the similar task recommendation program 110A, 110B may prompt a user to review the predicted similar task and ask the user to resolve a similar task. In one embodiment, the similar task recommendation program 110A, 110B may require a user to use the same tools and the same platforms to complete the rendered task such that the similar task recommendation program 110A, 110B may compare the time spent on both tasks accurately.

At 212, the similar task recommendation program 110A, 110B allows a user to resolve the next similar task. According to one embodiment the similar task recommendation program 110A, 110B may determine whether the user has resolved the rendered similar task by comparing the output or the end product of both tasks. For example, if task A requires a user to print out a report and then, the similar task recommendation program 110A, 110B may determine that the user has resolved the similar task A′ when the user prints out another report for task A′. In at least one other embodiment, the similar task recommendation program 110A, 110B may continuously monitor the time spent on a similar task and collect information as to the user's unique behaviors when resolving the rendered similar task. For example, if a user extensively relies on a usage of a calculator or spreadsheet when resolving the original task, the similar task recommendation program 110A, 110B may store such information to compare against any behavior presented by the same user when handling the similar task.

At 214, the similar task recommendation program 110A, 110B determines whether the time spent for the completion of a similar task exceeds the predicted time. If the similar task recommendation program 110A, 110B determines that the time spent for the completion of the similar task exceeds the predicted time (step 214, “Yes” branch), the similar task recommendation program 110A, 110B may continue to step 220 to label such a task as “not similar” and store such information in a database. If the similar task recommendation program 110A, 110B determines that the time spent for the completion of the similar task does not exceed the predicted time (step 214, “No” branch), the similar task recommendation program 110A, 110B may continue to step 216 to determine whether the observed user interaction indicates a complex decision making.

At 216, the similar task recommendation program 110A, 110B determines whether user interaction indicates complex decision making. If the similar task recommendation program 110A, 110B determines that the user interaction indicates a complex decision making (step 216, “Yes” branch), the similar task recommendation program 110A, 110B may then continue to step 220 to label the task as “not similar” and store the information in a database. If the similar task recommendation program 110A, 110B determines that the user interaction does not indicate a complex decision making (step 216, “No” branch), then the similar task recommendation program 110A, 110B may proceed to step 218 to label the task as “similar”. For example, if a user uses a complex pattern of interaction with the user interface, such as opening the details of the persons that are part of the task or opening certain applications that were not utilized when the user was resolving the original task.

At 218, the similar task recommendation program 110A, 110B labels tasks as similar. According to one embodiment, the similar task recommendation program 110A, 110B may label the predicted similar tasks as “similar” in a database when a user's time spent on the predicted similar tasks does not exceed the predicted time to be spent and the user does not show different behavior or different interaction with the user interface when resolving the predicted similar task.

At 220, the similar task recommendation program 110A, 110B labels tasks as not similar. According to one embodiment, the similar task recommendation program 110A, 110B may label certain tasks as “not similar” when a user spends more time to resolve the predicted similar task and the user shows a different pattern of interaction with the user interface when resolving the predicted similar task.

At 222, the similar task recommendation program 110A, 110B uses labeled tasks to train a machine learning system. According to one embodiment, the similar task recommendation program 110A, 110B may train a machine learning similar task algorithm using the information collected from step 214 and 216. For example, if a user spends more time than the predicted time on a similar task, the similar task recommendation program 110A, 110B may store the actual amount of time and the difference of the time and classify the task as either “similar” or “not similar”. The similar task recommendation program 110A, 110B may use both “similar” and “not similar” tasks to train the machine learning system to predict another similar task at step 206. In at least one other embodiment, the similar task recommendation program 110A, 110B may automatically iterate to train the machine learning system by inputting the labeled information or classification.

At 224, the similar task recommendation program 110A, 110B uses the time spent on the predicted similar tasks to train a machine learning time algorithm. According to one embodiment, the similar task recommendation program 110A, 110B may monitor and measure the exact amount of the time spent on the task at step 204 and step 212. The time spent on the original task may be measured at step 204 and the time spent on the predicted similar task may be measured at step 212. The similar task recommendation program 110A, 110B may then use both the measured time to train the machine learning time algorithm to determine a correlation between the similarity of two tasks and a difference in the time measured. In at least one other embodiment, the similar task recommendation program 110A, 110B may augment the machine learning similar task algorithm at step 222 with the information the machine learning system collected at step 224 to generate the next similar task.

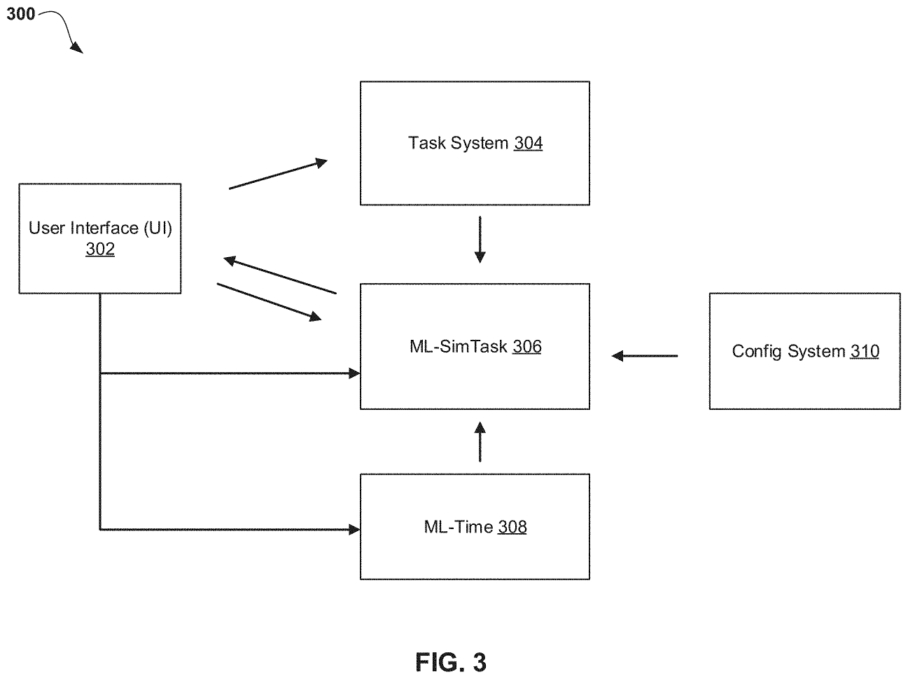

Referring now to FIG. 3, a functional block diagram of a similar task recommendation process 300 is depicted according to at least one embodiment. According to one embodiment, the similar task recommendation program 110A, 110B comprises a user interface 302, a task system 304, a machine learning similar task system 306, a machine learning time system 308, and a configuration system 310. In one embodiment, the user interface 302 may transmit information related to time spent to resolve a similar task to the machine learning similar task system 306 and the machine learning time system 308. The task system 304 may receive information relating to resolved tasks from the user interface 302. The task system 304 may transmit a list of the resolved tasks to the machine learning similar task system 306. The machine learning time system 308 may determine an expected time to complete the next similar task and transmit the information to the machine learning similar task system 306. The machine learning similar task system 306 may receive user usage pattern configuration information from the configuration system 310. The machine learning similar task system 306 may transmit a next similar task to the user interface 302 and the user interface 302 may send user interaction feedback back to the machine learning similar task system 306 such that the machine learning similar task system 306 may continuously update the next similar task. In one embodiment, the machine learning time system 308 may utilize linear regression models or random forest models. In yet another embodiment, the machine learning similar task system 306 may utilize siamese neural network models.

Referring now to FIG. 4, a block diagram showing several examples of operation of a computer system for labeling tasks is depicted according to the various embodiments described herein.

It may be appreciated that FIGS. 2-4 provide only an illustration of one implementation and do not imply any limitations with regard to how different embodiments may be implemented. Many modifications to the depicted environments may be made based on design and implementation requirements. For example, in at least one embodiment, the similar task recommendation program 110A, 110B may identify a similar task for which a user used a simple interaction with the user interface spending a longer time than the predicted time to be spent and label such a similar task as an outlier by not labeling “similar” or “not similar”. The similar task recommendation program 110A, 110B may also label a task as an outlier by not labeling “similar” or “not similar” if complex decision-making processes were observed.

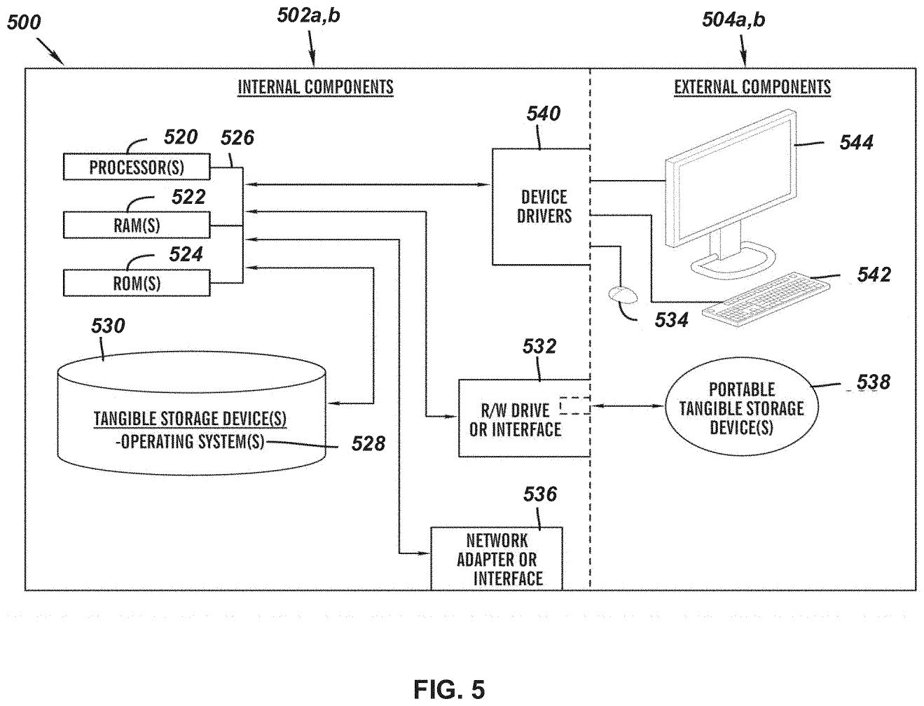

FIG. 5 is a block diagram 400 of internal and external components of the client computing device 102 and the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 502 a,b and external components 504 a,b illustrated in FIG. 5. Each of the sets of internal components 502 include one or more processors 520, one or more computer-readable RAMs 522, and one or more computer-readable ROMs 524 on one or more buses 526, and one or more operating systems 528 and one or more computer-readable tangible storage devices 530. The one or more operating systems 528, the software program 108 and the similar task recommendation program 110A in the client computing device 102 and the similar task recommendation program 110B in the server 112 are stored on one or more of the respective computer-readable tangible storage devices 530 for execution by one or more of the respective processors 520 via one or more of the respective RAMs 522 (which typically include cache memory). In the embodiment illustrated in FIG. 5, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a,b also includes an R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the similar task recommendation program 110A, 110B can be stored on one or more of the respective portable computer-readable tangible storage devices 538, read via the respective R/W drive or interface 532 and loaded into the respective hard drive 530.

Each set of internal components 502 a,b also includes network adapters or interfaces 536 such as a TCP/IP adapter cards, wireless Wi-Fi interface cards, or 3G or 4G wireless interface cards or other wired or wireless communication links. The software program 108 and the similar task recommendation program 110A in the client computing device 102 and the similar task recommendation program 110B in the server 112 can be downloaded to the client computing device 102 and the server 112 from an external computer via a network (for example, the Internet, a local area network or other, wide area network) and respective network adapters or interfaces 536. From the network adapters or interfaces 536, the software program 108 and the similar task recommendation program 110A in the client computing device 102 and the similar task recommendation program 110B in the server 112 are loaded into the respective hard drive 530. The network may comprise copper wires, optical fibers, wireless transmission, routers, firewalls, switches, gateway computers and/or edge servers.

Each of the sets of external components 504 a,b can include a computer display monitor 544, a keyboard 542, and a computer mouse 534. External components 504 a,b can also include touch screens, virtual keyboards, touch pads, pointing devices, and other human interface devices. Each of the sets of internal components 502 a,b also includes device drivers 540 to interface to computer display monitor 544, keyboard 542, and computer mouse 534. The device drivers 540, RAY drive or interface 532, and network adapter or interface 536 comprise hardware and software (stored in storage device 530 and/or ROM 524).

It is understood in advance that although this disclosure includes a detailed description on cloud computing, implementation of the teachings recited herein is not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure comprising a network of interconnected nodes.

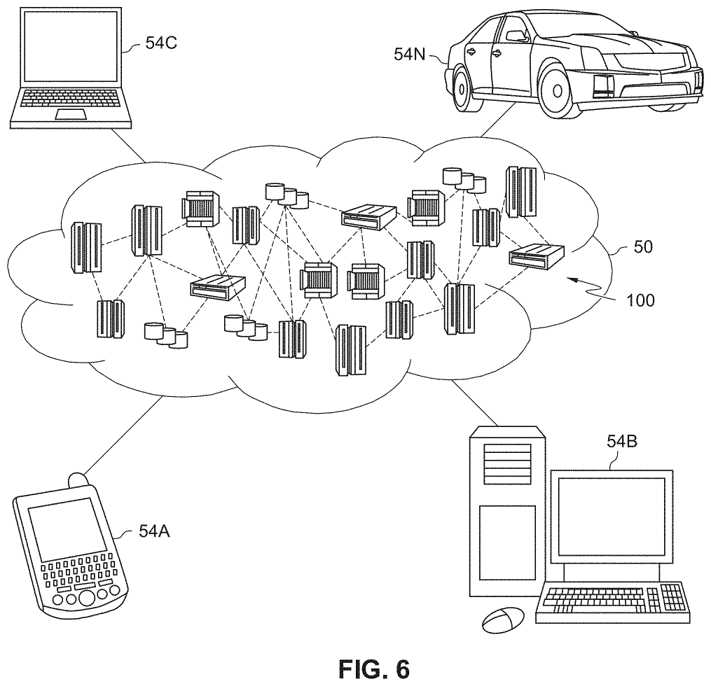

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

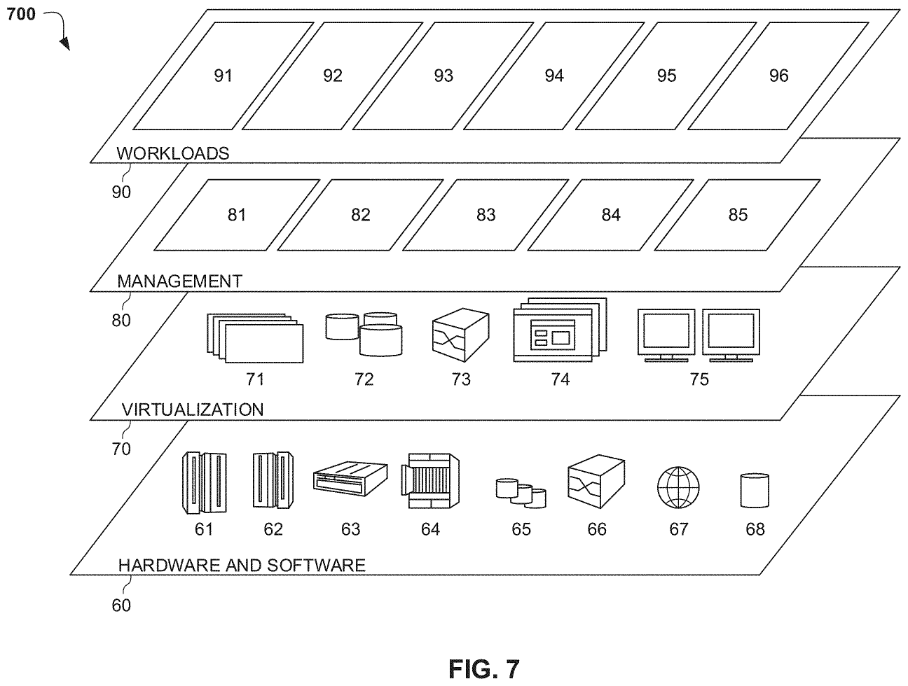

Referring now to FIG. 7, a set of functional abstraction layers 700 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and similar task recommendation 96. Similar task recommendation 96 may relate to automated learning and improving similar task recommendations based on user interaction information.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for training a machine learning model for use by a task management system, the method comprising:
presenting a task to be resolved to a user via a user interface;
presenting a further task to be resolved to the user via the user interface;
predicting time to be spent on the further task presented to the user;
determining actual time the user spent for completing the further task; and
training a machine learning model for a subsequent similar task based on the predicted time and the determined actual time.

2. The method of claim 1, wherein predicting the time to be spent for the further task is based on a further machine learning model.

3. The method of claim 1, further comprising:
transmitting the subsequent similar task to the user via the user interface.

4. The method of claim 1, further comprising:
monitoring user interaction with the user interface when the user spends more time for completing the further task.

5. The method of claim 4, further comprising:
training the machine learning model based on information extracted from the monitored user interaction.

6. The method of claim 4, further comprising:
determining whether the further task is more complex than the presented task based on the monitored user interaction.

7. The method of claim 4, further comprising:
in response to the user interaction indicating that the further task requires more interaction with the user interface, determining that the further task is not similar to the presented task.

8. A computer system for training a machine learning model for use by a task management system, the computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
presenting a task to be resolved to a user via a user interface;
presenting a further task to be resolved to the user via the user interface;
predicting time to be spent on the further task presented to the user;
determining actual time the user spent for completing the further task; and
training a machine learning model for a subsequent similar task based on the predicted time and the determined actual time.

9. The computer system of claim 8, wherein predicting the time to be spent for the further task is based on a further machine learning model.

10. The computer system of claim 8, further comprising:
transmitting the subsequent similar task to the user via the user interface.

11. The computer system of claim 8, further comprising:
monitoring user interaction with the user interface when the user spends more time for completing the further task.

12. The computer system of claim 11, further comprising:
training the machine learning model based on information extracted from the monitored user interaction.

13. The computer system of claim 11, further comprising:
determining whether the further task is more complex than the presented task based on the monitored user interaction.

14. The computer system of claim 11, further comprising:
in response to the user interaction indicating that the further task requires more interaction with the user interface, determining that the further task is not similar to the presented task.

15. A computer program product for training a machine learning model for use by a task management system, the computer program product comprising:
one or more computer-readable tangible storage media and program instructions stored on at least one of the one or more tangible storage media, the program instructions executable by a processor of a computer to perform a method, the method comprising:
presenting a task to be resolved to a user via a user interface;
presenting a further task to be resolved to the user via the user interface;
predicting time to be spent on the further task presented to the user;
determining actual time the user spent for completing the further task; and
training a machine learning model for a subsequent similar task based on the predicted time and the determined actual time.

16. The computer program product of claim 15, wherein predicting the time to be spent for the further task is based on a further machine learning model.

17. The computer program product of claim 15, further comprising:
transmitting the subsequent similar task to the user via the user interface.

18. The computer program product of claim 15, further comprising:
monitoring user interaction with the user interface when the user spends more time for completing the further task.

19. The computer program product of claim 18, further comprising:
training the machine learning model based on information extracted from the monitored user interaction.

20. The computer program product of claim 18, further comprising:
determining whether the further task is more complex than the presented task based on the monitored user interaction.
